(19) United States
(12) Patent Application Publication
(10) Pub. No.: US 2011/0005895 A1
(43) Pub. Date: Jan. 13, 2011

(54) PART ALIGNING APPARATUS AND METHOD

(75) Inventors: Do Gyoon KIM, Yongin-si (KR); Jong Myeon PARK, Incheon-si (KR); Hyun Min KIM, Gwangju-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 12/817,913

(22) Filed: Jun. 17, 2010

(30) Foreign Application Priority Data
Jul. 13, 2009 (KR) 10-2009-0063413

(51) Int. Cl. B65G 47/00; B65G 27/02; B65G 47/34; B65G 47/52

(52) U.S. Cl. 198/358

(57) ABSTRACT

A part aligning apparatus and method are provided. The part aligning apparatus includes a vibrating container unit which transfers parts having a nonsymmetrical structure, an alignment direction setting unit which receives the parts transferred by the vibrating container unit, and passes parts aligned in a first alignment direction and returns to the vibrating container unit parts aligned in a second alignment direction different from the first alignment direction, based on a size difference of contact portions of the parts according to alignment directions of the transferred parts, and an ejecting unit which receives the parts passed through the alignment direction setting unit and sequentially ejects the received parts to an inlet of a tray.

### CROSS-REFERENCE TO RELATED APPLICATION

This application claims priority from Korean Patent Application No. 2009-0063413, filed on Jul. 13, 2009 in the Korean Intellectual Property Office, the disclosure of which is incorporated herein by reference.

### BACKGROUND OF THE INVENTION

1. Field

Apparatuses and methods consistent with exemplary embodiments relate to aligning, nonsymmetrical parts having different arrangements according to alignment directions so as to have a designated direction.

2. Description of the Related Art

Methods and apparatuses of analyzing samples in various application fields, such as environmental monitoring, food examination, medical diagnosis, etc., have been developed. In order to perform an examination based on a set protocol, a skilled examiner should manually perform various steps including reagent injection, mixing, separation, movement, reaction, and centrifugal separation many times. However, this examination method may cause errors in the examination results.

In order to rapidly perform examinations, a skilled clinical pathologist is required. Even the skilled clinical pathologist may have difficulty in simultaneously performing various examinations. However, in diagnosis of a patient in an emergency situation, rapid acquisition of examination results is required to perform rapid emergency measures. Therefore, an apparatus, which simultaneously and rapidly performs various necessary pathological examinations according to circumstances, is needed.

In order to address the above problems, automated apparatuses, which rapidly analyze samples extracted from one patient or a few patients if necessary, have been developed. For example, a disc-type microfluidic device has been developed. A sample containing a body fluid, such as blood, is injected into a disc-type microfluidic device and the disc-type microfluidic device is rotated to mix the sample with a reagent using centrifugal force and thus analyze the sample.

Cartridges, into which the sample is injected, are arranged on the disc-type microfluidic device. The cartridges are aligned on a tray before and after the sample is injected into the cartridges. Since the cartridges generally have a nonsymmetrical structure, an operation of aligning the cartridges in a designated direction on the tray.

### SUMMARY OF THE INVENTION

One or more exemplary embodiments provide a part aligning apparatus and method, which aligns parts so as to have a designated direction.

One or more exemplary embodiments also provide a part aligning apparatus and method, which senses direction of parts.

According to an aspect of an exemplary embodiment, there is provided a part aligning apparatus including a vibrating container unit which transfers parts having a nonsymmetrical structure along a transfer path, an alignment direction setting unit which receives the parts transferred by the vibrating container unit, and passes parts aligned in a first alignment direction and returns to the vibrating container unit parts aligned in a second alignment direction different from the first alignment direction, based on a size difference of contact portions of the parts according to alignment directions of the transferred parts, and an ejecting unit which receives the parts passed through the alignment direction setting unit and sequentially ejects the received parts to an inlet of a tray.

The part aligning apparatus may further include a pusher which pushes the parts from the ejecting unit into the tray.

The ejection unit may fill a row of the tray with the parts passed through the alignment direction setting unit and then fill a next row of the tray with parts passed through the alignment direction setting unit.

The size difference of the contact portions may be a height difference, and the alignment direction setting unit includes a return hole through which the parts aligned in the second direction are returned to the vibrating container depending on the height difference.

The alignment direction setting unit may further include a noncontact section and at least one contact section having a height which is less than a height of the noncontact section, and the noncontact section may pass the parts aligned in the second alignment direction into the return hole due to the height difference.

The alignment direction setting unit may further include first and second supporters which support the parts transferred above the return hole in two directions, and the second supports the upper portions of the side surfaces of the transferred parts, may include the contact section and the noncontact section.

The alignment direction setting unit may include a direction changing unit which changes the alignment directions of the parts.

The direction changing unit may include a protrusion.

The part aligning apparatus may further include a sensor unit which senses the alignment directions of the parts and may be installed on the ejecting unit, and, if the alignment direction of a part sensed by the sensor unit is not a desired alignment direction, the part is prevented from being ejected from the ejecting unit into the tray.

The part aligning apparatus may further include a part dropping rail which is inclined downward and transfers the parts passed through the alignment direction setting unit to the ejecting unit.

The part dropping rail may include a cover provided at an upper part thereof so as to prevent the parts from being separated from the part dropping rail.

The ejecting unit may include a seat portion which accommodates a part discharged from the part dropping rail into the ejecting unit, and when the part is accommodated in the seat portion, the ejecting unit moves while preventing discharge of a next part from the part dropping rail.

The ejecting unit may further include a suction portion which fixes the part accommodated in the seat portion to prevent the part from being separated from the ejecting unit while the ejecting unit moves.

According to an aspect of another exemplary embodiment, there is provided a part aligning method including transferring parts having a nonsymmetrical structure along a transfer path by vibration, setting alignment directions of the transferred parts by passing parts aligned in a first alignment direction and not passing parts aligned a second alignment direction based on a size difference of contact portions of the parts according to alignment directions of the transferred parts, and sequentially inserting the parts, the alignment directions of which are set, into a tray.

The size difference of the contact portions may be a height difference.

The setting the alignment directions of the parts may include changing the alignment directions of the passed parts.

The part aligning method may further include sensing the alignment directions of the parts, the alignment directions of which have been set, and separating the tray from an operation position, if it is sensed that the alignment direction of a part sensed by the sensor unit is not the desired alignment direction.

The part aligning method may further include moving the tray at a designated interval, whenever a row of the tray is filled with the parts, so as to fill a next row with the parts.

### BRIEF DESCRIPTION OF THE DRAWINGS

These and/or other aspects will become apparent and more readily appreciated from the following description of exemplary embodiments, taken in conjunction with the accompanying drawings of which:

FIG. 1 is a view illustrating one example of a part, which may be applied to a part aligning apparatus in accordance with an exemplary embodiment;

FIG. 2 is an entire perspective view of a part aligning apparatus in accordance with an exemplary embodiment;

FIG. 3 is a partial perspective view of the part aligning apparatus shown in FIG. 2;

FIG. 4 is an enlarged view of an alignment direction setting unit of the part aligning apparatus of FIG. 3;

FIG. 5 is a front view of a first supporter and a second supporter of the alignment direction setting unit of FIG. 4;

FIGS. 6A and 6B are longitudinal-sectional views of FIG. 4 taken along the line I-I′, more specifically;

FIG. 6A illustrates a state in which a cartridge in a desired alignment direction is transferred; and

FIG. 6B illustrates a state in which a cartridge in a different alignment direction is put into a return hole;

FIG. 7 is a plan view of the alignment direction setting unit illustrating a state in which the alignment direction of a cartridge is changed by a direction changing unit;

FIG. 8 is a view schematically illustrating a part dropping rail, an ejecting unit, and a pusher of the part aligning apparatus according to an exemplary embodiment;

FIG. 9 is a longitudinal-sectional view of the ejecting unit;

FIGS. 10A to 10D are views illustrating an operating procedure of the ejecting unit and the pusher to take a regular-directional cartridge out of the part dropping rail and then to insert the cartridge into a tray according to an exemplary embodiment; and

FIG. 11 is a flow chart illustrating operation of the part aligning apparatus in accordance with an exemplary embodiment.

### DETAILED DESCRIPTION OF EXEMPLARY EMBODIMENTS

Exemplary embodiments will now be described in detail with reference to the accompanying drawings, wherein like reference numerals refer to like elements throughout.

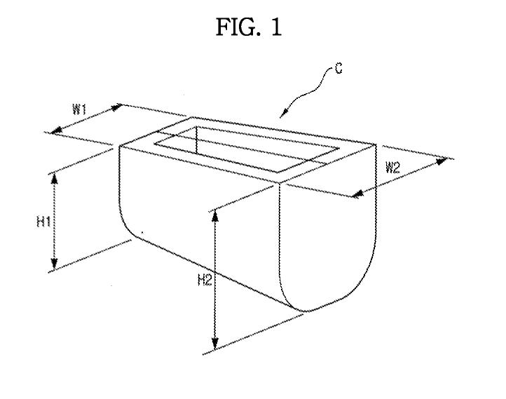

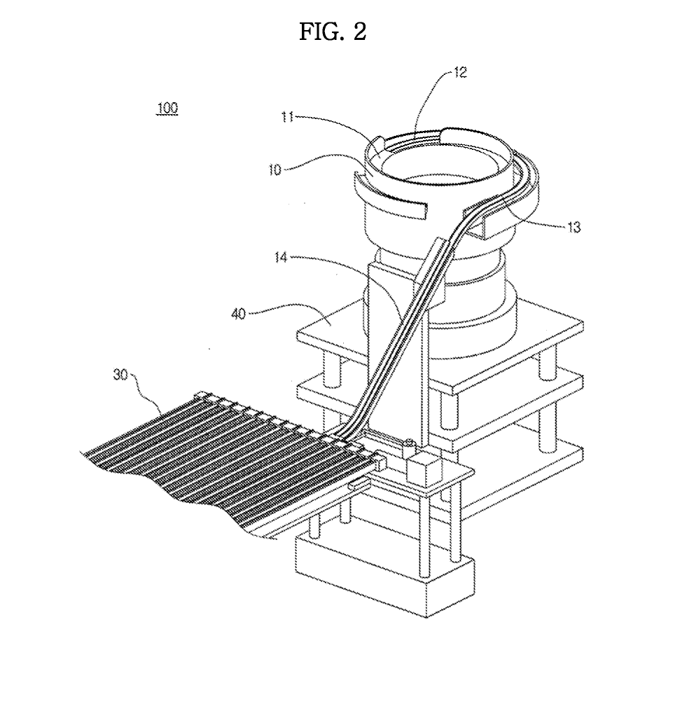

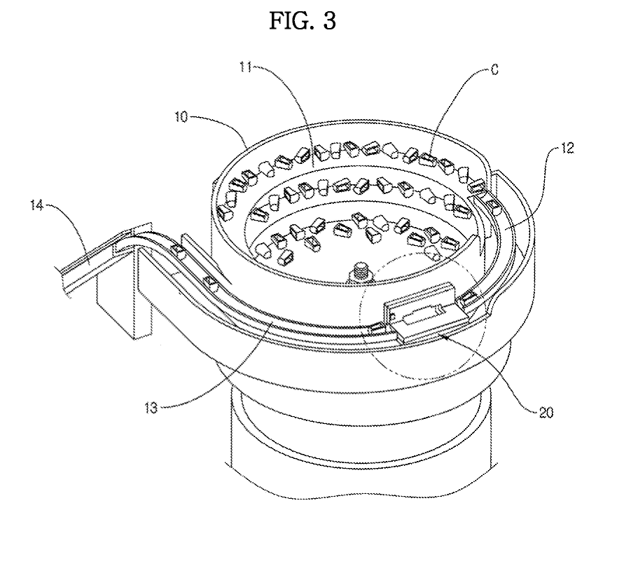

FIG. 1 is a view illustrating one example of a part, which may be applied to a part aligning apparatus in accordance with an exemplary embodiment, FIG. 2 is a general perspective view of a part aligning apparatus in accordance with an exemplary embodiment, and FIG. 3 is a partial perspective view of the part aligning apparatus shown in FIG. 2.

Prior to description, a part, which may be applied to a part aligning apparatus 100 in accordance with an exemplary embodiment, may be a cartridge C having a nonsymmetrical structure such that a front height H1 thereof is smaller than a rear height H2 thereof and a front width W1 thereof is smaller than a rear width W2 thereof, as shown in FIG. 1. However, the descriptors “front” and “rear” are used for merely for convenience of explanation and the part having the nonsymmetrical structure is not limited to the cartridge C shown in FIG. 1, but all parts having a nonsymmetrical structure with different heights or widths according to portions thereof may be applied to the part aligning apparatus 100 in accordance with this embodiment.

With reference to FIGS. 2 and 3, the part aligning apparatus in accordance with this embodiment includes a vibrating container unit 10 having an inner space to contain cartridges C having a nonsymmetrical structure, an alignment direction setting unit 20 installed on the vibrating container unit 10 to set an alignment direction of the cartridges C, and a tray 30, into which the aligned cartridges C are inserted.

A vibration generator 40 is installed under the vibrating container unit 10, and provides vibration to the vibrating container unit 10. A protruding transfer path 11 is formed on the inner wall of the vibrating container unit 10. The transfer path 11 may be formed in a spiral shape from the bottom portion of the vibrating container unit 10 to the top potion of the vibrating container unit 10. Further, the transfer path 11 may have a width, through which only one or two cartridges C pass. The plural cartridges C contained in the vibrating container unit 10 slightly move from the bottom portion of the vibrating container unit 10 to the top portion of the vibrating container unit 10 along the transfer path 11 due to the vibration generated by the vibration generator 40.

A first transfer rail 12 is installed between the top portion of the vibrating container unit 10, where the transfer path 11 ends, and the alignment direction setting unit 20. The first transfer rail 12 is inclined downward from the top portion of the vibrating container unit 10 to the alignment direction setting unit 20, and allows the cartridges C to be easily transferred to the alignment direction setting unit 20. Further, the first transfer rail 12 has steps, which are gradually lowered at designated intervals along a transfer route, and thus as the cartridges C pass through the steps, the cartridges C uniformly maintain their alignment direction. Although this embodiment describes the first transfer rail 12 formed in an arc shape, the first transfer rail 12 may have various other shapes, such as a straight shape and a curved shape.

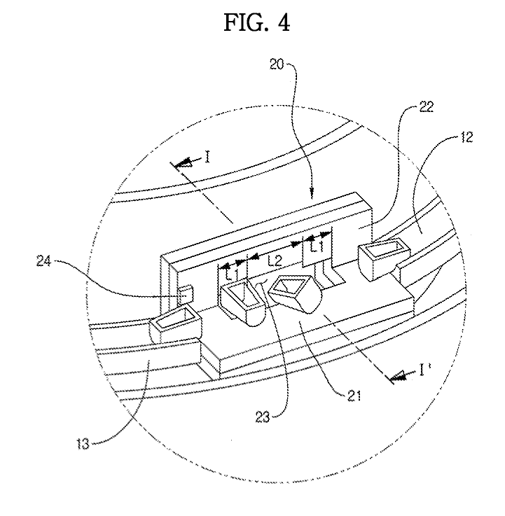

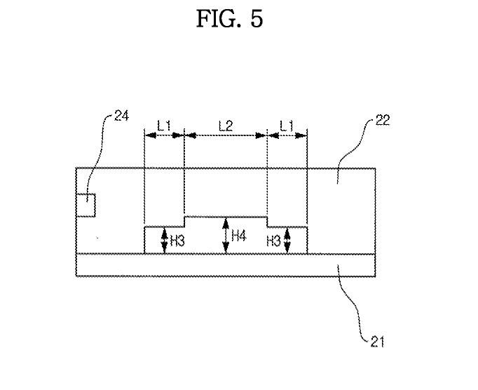

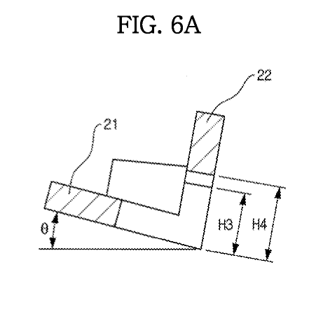

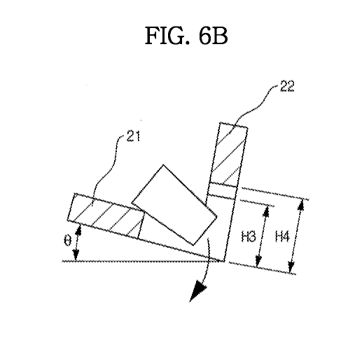

FIG. 4 is an enlarged view of the alignment direction setting unit of the part aligning apparatus of FIG. 3, FIG. 5 is a front view of a first supporter and a second supporter of the alignment direction setting unit of FIG. 4, FIGS. 6A and 6B are longitudinal-sectional views of FIG. 4 taken along the line I-I′, and more specifically FIG. 6A illustrates a state in which a cartridge in a desired alignment direction is transferred, and FIG. 6B illustrates a state in which a cartridge in a different alignment direction is put into a return hole.

With reference to FIG. 4, the alignment direction setting unit 20 includes a pair of a first supporter 21 and a second supporter 22, which supports the cartridges C supplied from the first transfer rail 12 in two directions. The first supporter 21 and the second supporter 22 are disposed such that they intersect each other, as shown in FIGS. 6A and 6B, and thus the first supporter 21 may contact and support the side portion of the lower surface of the cartridge C and the second supporter 22 may contact and support the upper portion of the side surface of the cartridge C. At a designated interval, the first supporter 21 and the second supporter 22 are separated from each other by a return hole 23 opening to the vibrating container unit 10. Although in this embodiment, the crossing angle of the first supporter 21 and the second supporter 22 is 90 degrees, the crossing angle may be variously modified according to the shapes of the cartridges C.

The second supporter 22 includes contact sections L1 and a noncontact section L2 provided in the transfer direction of the cartridges C. The noncontact section L2 causes a cartridge in an undesired alignment direction to be put into the return hole 23 due to a size difference with the contact sections L1. The part aligning apparatus 100 in accordance with this exemplary embodiment causes a cartridge in an undesired alignment direction to be put into the return hole 23 using a difference of heights between the cartridges C and the contact sections L1 of the second supporter 22.

The contact sections L1 and the noncontact section L2 of the second supporter 22 have different heights with respect to a contact surface of the first supporter 21. For example, as shown in FIG. 5, the height H4 of the noncontact section L2 is greater than the height H3 of the contact sections L1. In the cartridge C shown in FIG. 1, supposing that a surface of the cartridge C having a width W1 and a height H1 is referred to as a front surface and another surface of the cartridge C having a width W2 greater than the width W1 and a height H2 greater than the height H1 is referred to as a rear surface, the height H3 of the contact sections L1 is less than the height H2 of the rear surface of the cartridge C such that the contact sections L1 supports the rear surface of the cartridge C but is greater than the height H1 of the front surface of the cartridge C such that the contact sections L1 do not support the front surface of the cartridge C.

A difference ΔH1 between the height H3 of the contact sections L1 and the height H4 of the noncontact section L2 may be determined by a difference ΔH2 between the height H1 of the front surface of the cartridge C and the height H2 of the rear surface of the cartridge C.

With reference to FIG. 6A, if the cartridge C transferred from the first transfer rail 12 is aligned by vibration and the rear surface of the cartridge C contacts the second supporter 22 (if the cartridge C is in a desired alignment direction), the cartridge C moves along the first and second supporters 21 and 22 under the condition that the cartridge C is supported by the second supporter 22 in both the contact sections L1 and the noncontact section L2. On the other hand, as shown in FIG. 6B, if the front surface of the cartridge C contacts the second supporter 22 (if the cartridge C is in a undesired alignment direction), the cartridge C is supported by the second supporter 22 in the initial contact section L1 and thus moves, but the cartridge C is not supported by the second supporter 22 in the noncontact section L2 due to a height difference and thus falls into the return hole 23.

Further, the first supporter 21, as shown in FIGS. 6A and 6B, may be inclined at a designated angle θ from a horizontal plane. This inclination of the first supporter 21 serves to induce the cartridge C to contact the first supporter 21 and the second supporter 22.

Although this exemplary embodiment describes that the contact section L1, the noncontact section L2, and the contact section L1 are sequentially disposed on the second supporter 22 along the transfer direction of the cartridge C, the sequence and the number of the contact sections L1 and the noncontact section L2 may be variously modified. That is, plural noncontact sections may be provided at designated intervals so as to increase a probability that the cartridge C in a undesired alignment direction falls into the return hole 23. Further, the second supporter 22 may include only noncontact sections.

Further, a direction changing unit 24 to change the alignment direction of the cartridge C passed through the noncontact section L2 may be formed at the tip of the second supporter 22. For example, the direction changing unit 24 may be a protrusion extending from the second supporter 22.

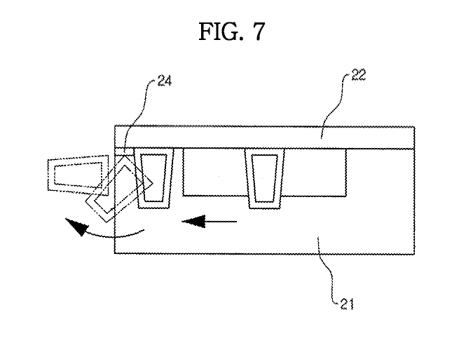

FIG. 7 is a plan view of the alignment direction setting unit illustrating a state in which the alignment direction of the cartridge is changed by the direction changing unit. As shown in FIG. 7, the cartridge C is rotated by an angle of 90 degrees by the protrusion serving as the direction changing unit 24, and thus the front surface of the cartridge C faces forward. Hereinafter, a cartridge C having the above alignment direction is referred to as “a regular-directional cartridge C”, and a cartridge C having the inverse alignment direction is referred to as “an inverse-directional cartridge C”.

The regular-directional cartridge C passed through the alignment direction setting unit 20 is transferred along a second transfer rail 13, as shown in FIG. 3. The second transfer rail 13 has a similar function to that of the first transfer rail 12, and thus a detailed description thereof will be omitted.

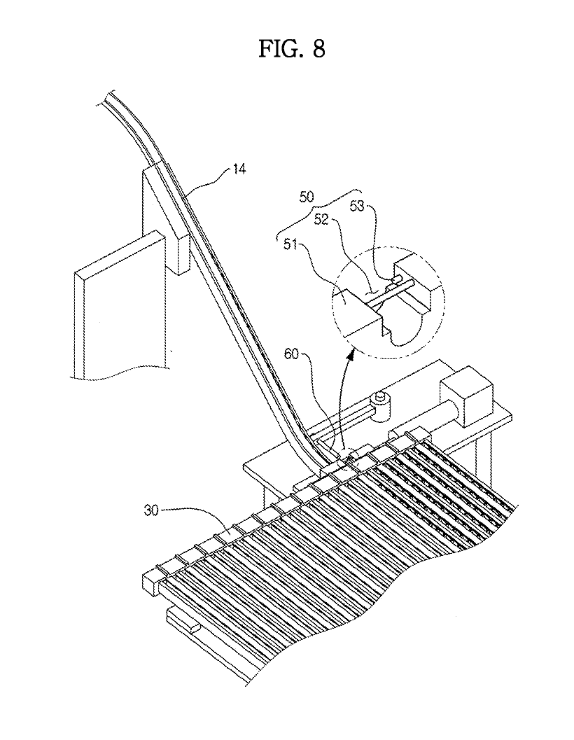

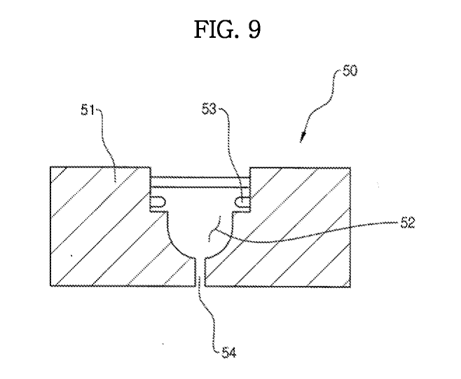

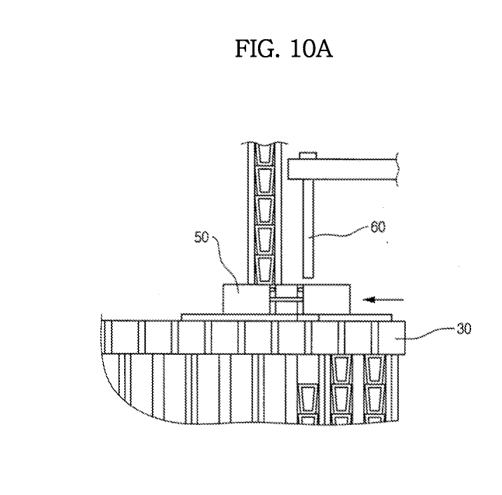

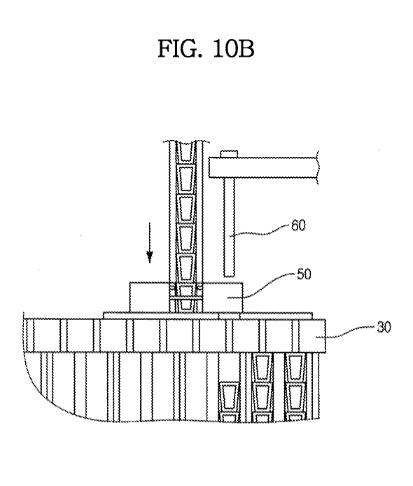

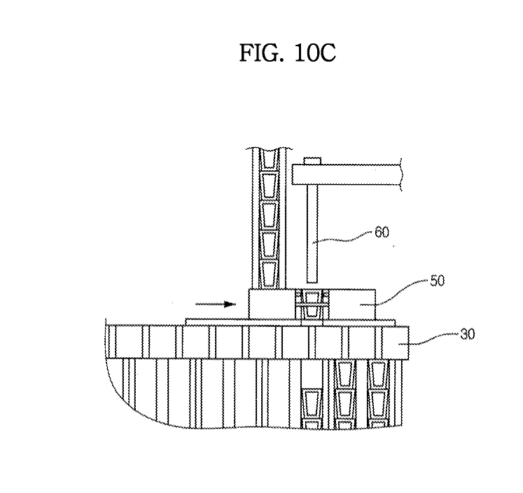

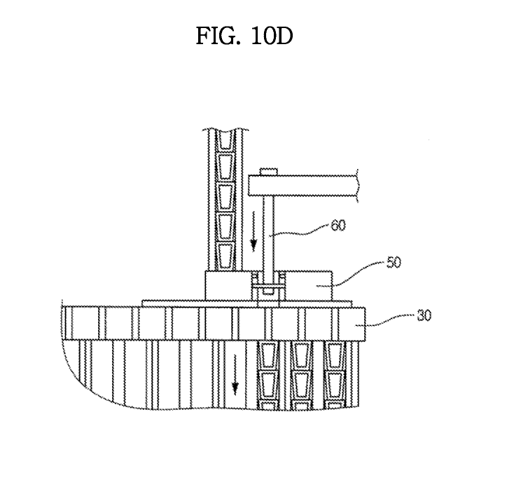

FIG. 8 is a view schematically illustrating a part dropping rail, an ejecting unit, and a pusher of the part aligning apparatus according to an exemplary embodiment, FIG. 9 is a longitudinal-sectional view of the ejecting unit, and FIGS. 10A to 10D are views illustrating an operating procedure of the ejecting unit and the pusher to eject a regular-directional cartridge out of the part dropping rail and then to insert the cartridge into the tray according to an exemplary embodiment.

With reference to FIG. 8, a part dropping rail 14 is connected to the tip of the second transfer rail 13, and is inclined downward. Although this exemplary embodiment describes the part dropping rail 14 formed in a straight shape, the part dropping rail 14 may be modified to various shapes, such as a curved shape. Further, the part dropping rail 14 may be provided with guide walls respectively formed at both sides thereof and a cover formed at the upper part thereof so as to prevent the cartridge C from being separated from the part dropping rail 14. The cartridge C moves to an outlet, where an ejecting unit 50 is provided, along the part dropping rail 14 due to the inclination of the part dropping rail 14.

A seat portion 52 to accommodate the cartridge C is formed between both side walls 51 of the ejecting unit 50 installed at the outlet of the part dropping rail 14. The bottom surface of the seat portion 52 has a shape corresponding to the lower surface of the cartridge C such that the cartridge C is more stably located in the seat portion 52. The ejecting unit 50 is configured such that it may reciprocate in a direction crossing the part dropping rail 14.

Further, a sensor unit 53 is provided on the inner surface of at least one of the side walls of the ejecting unit 50, and senses whether the cartridge C accommodated in the seat portion 52 is a regular-directional cartridge or an inverse-directional cartridge. The sensor unit 53 may be an optical sensor which recognizes a change, such as transmission and reflection of light, due to a height difference by the alignment of the regular-directional cartridge or the inverse-directional cartridge, and thus distinguishes the regular-directional cartridge or the inverse-directional cartridge.

The ejecting unit 50, as shown in FIG. 9, includes a suction portion 54 provided at the bottom of the seat portion 52. The suction portion 54 can prevent the cartridge C from being separated from the ejecting unit 50 when the ejecting unit 50 moves. The suction portion 54 may include a suction hole formed through the lower portion of the seat portion 52, and a vacuum generator (not shown) to generate suction force for the suction hole. For example, a vacuum pump may be used as the vacuum generator.

A pusher 60 reciprocates so as to push the regular-directional cartridge C accommodated in the seat portion 52 of the ejecting unit 50 into the tray 30. For example, the pusher 60 may have a long rod shape.

Hereinafter, a process of inserting a regular-directional cartridge C into the tray 30 will be described with reference to FIGS. 10A to 10D.

First, as shown in FIG. 10A, the side walls 51 of the ejecting unit 50 close the outlet of the part dropping rail 14 to prevent the discharge of the cartridge C. When the ejecting unit 50 moves to one side and the seat portion 52 coincides with the outlet of the part dropping rail 14, as shown in FIG. 10B, the cartridge C enters the seat portion 52 due to the inclination of the part dropping rail 14. Here, the suction portion 54 of the ejecting unit 50 operates to stably fix the cartridge C to the seat portion 52.

The ejecting unit 50, in which the cartridge C is accommodated, moves to the other side, where an inlet of the tray 30 is located, as shown in FIG. 10C. Here, the ejecting unit 50 closes the outlet of the part dropping rail 14 using the side walls 51 so as to prevent the discharge of a next cartridge C on standby while causing the seat portion 52 to coincide with the inlet of the tray 30. Thereafter, when the pusher 60, as shown in FIG. 10D, pushes the cartridge C accommodated in the seat portion 52 to the inlet of the tray 30, the input of the cartridge C into the tray 30 is completed.

On the other hand, if the sensor unit 53 recognizes that the cartridge C accommodated in the seat portion 52 of the ejecting unit 50 as an inverse-directional cartridge C, the tray 30 is deviated from an operation position by the driving unit. Therefore, when the pusher 60 pushes the inverse-directional cartridge C, the inverse-directional cartridge C is not put into the tray 30, but is discharged to the outside. After the inverse-directional cartridge C is removed, the tray 30 is returned to the operation position.

When one row of the tray 30 is filled with regular-directional cartridges C by the repetition of the above process, the tray 30 moves to a position separated from the current position by a designated interval so as to fill the next row with regular-directional cartridges C. Thereby, all the rows of the tray 30 are filled with regular-directional cartridges C.

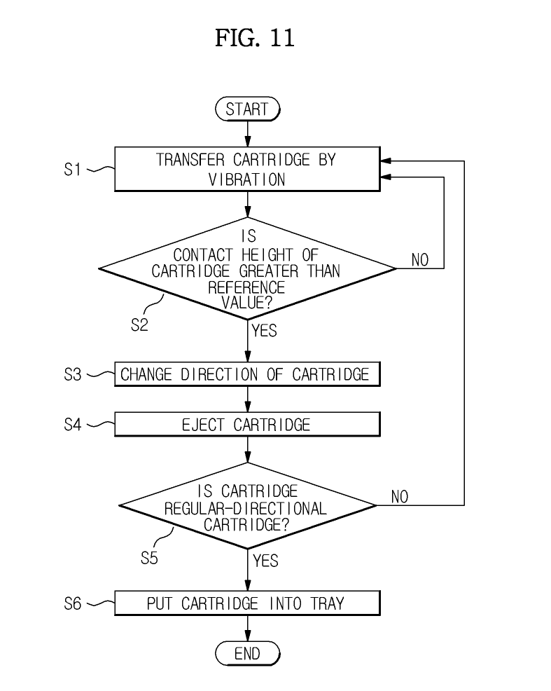

FIG. 11 is a flow chart illustrating operation of the part aligning apparatus in accordance with this exemplary embodiment.

With reference to FIG. 11, plural cartridges C are transferred in one direction by vibration of the vibration generator 40 (S1). Then, if the contact height of a transferred cartridge C in the alignment direction setting unit 20 is greater than a reference value (S2—YES), i.e., if the rear surface of the cartridge C contacts the second supporter 22, the cartridge C passes through the alignment direction setting unit 20. Alternatively, if the contact height of the transferred cartridge C in the alignment direction setting unit 20 is not greater than the reference value (S2—No), i.e., if the front surface of the cartridge C contacts the second supporter 22, the cartridge C is ejected through the return hole 23 (S2).

The cartridge C having passed through the alignment direction setting unit 20 is rotated by an angle of 90 degrees and is aligned in the direction for regular-directional cartridges (S3), and then is ejected via the ejecting unit 50 (S4). Here, the sensor unit 53 of the ejecting unit 50 senses again the alignment direction of the cartridge C, and thus determines whether the cartridge C is a regular-directional cartridge or an inverse-directional cartridge (S5). If it is determined that the cartridge C is a regular-directional cartridge (S5—YES), the cartridge C is inserted into the tray 30 by the pusher (S6). Alternatively, if it is judged that the cartridge C is an inverse-directional cartridge (S5—NO), the cartridge C is discharged to the outside of the tray 30 and then is returned to the vibrating container unit 10. By the repetition of the above operation, the cartridges C are arranged in the tray 30 in a regular alignment direction.

As is apparent from the above description, in the part aligning apparatus and method in accordance with the exemplary embodiments, parts are aligned so as to have a designated direction, and directions of the parts are sensed so that parts having an undesired direction may be removed.

Although a few exemplary embodiments have been shown and described, it would be appreciated by those skilled in the art that changes may be made in these exemplary embodiments without departing from the principles and spirit of the inventive concept, the scope of which is defined in the claims and their equivalents.

What is claimed is:

1. A part aligning apparatus comprising:
a vibrating container unit which transfers parts having a nonsymmetrical structure along a transfer path;
an alignment direction setting unit which receives the parts transferred by the vibrating container unit, and passes parts aligned in a first alignment direction and returns to the vibrating container unit parts aligned in a second alignment direction different from the first alignment direction, based on a size difference of contact portions of the parts according to alignment directions of the parts; and
an ejecting unit which receives the parts passed through the alignment direction setting unit and sequentially ejects the received parts to an inlet of a tray.

2. The part aligning apparatus according to claim 1, further comprising a pusher to push the parts from the ejecting unit into the tray.

3. The part aligning apparatus according to claim 1, wherein the ejection unit fills a row of the tray with the parts passed through the alignment direction setting unit and then fills a next row of the tray with parts passed through the alignment direction setting unit.

4. The part aligning apparatus according to claim 1, wherein:
the size difference of the contact portions of the parts is a height difference; and
the alignment direction setting unit includes a return hole through which the parts aligned in the second direction are returned to the vibrating container depending on the height difference.

5. The part aligning apparatus according to claim 4, wherein:
the alignment direction setting unit further includes a noncontact section and at least one contact section having a height which is less than a height of the noncontact section; and
the noncontact section passes the parts aligned in the second alignment direction into the return hole due to the difference height between the noncontact section and contact section.

6. The part aligning apparatus according to claim 5, wherein:
the alignment direction setting unit further includes first and second supporters which support the parts transferred above the return hole in two directions; and
the second supporter supports upper portions of side surfaces of the transferred parts, and includes the noncontact section and the at least one contact section.

7. The part aligning apparatus according to claim 1, wherein:
the alignment direction setting unit includes a direction changing unit which changes the first and second alignment directions of the parts.

8. The part aligning apparatus according to claim 7, wherein the direction changing unit includes a protrusion.

9. The part aligning apparatus according to claim 1, further comprising:
a sensor unit which senses the alignment directions of the parts and is installed at the ejecting unit; and
if the alignment direction of a part sensed by the sensor unit is not a desired alignment direction, the part is prevented from being ejected from the ejecting unit into the tray.

10. The part aligning apparatus according to claim 1, further comprising a part dropping rail which is inclined downward and transfers the parts passed through the alignment direction setting unit to the ejecting unit.

11. The part aligning apparatus according to claim 10, wherein the part dropping rail includes a cover provided at an upper part thereof so as to prevent the parts from being separated from the part dropping rail.

12. The part aligning apparatus according to claim 10, wherein the ejecting unit includes a seat portion which accommodates a part discharged from the part dropping rail into the ejecting unit, and when the part is accommodated in the seat portion, the ejecting unit moves while preventing discharge of a next part from the part dropping rail.

13. The part aligning apparatus according to claim 12, wherein the ejecting unit further includes a suction portion which fixes the part accommodated in the seat portion to prevent the part from being separated from the ejecting unit while the ejecting unit moves.

14. A part aligning method comprising:
transferring parts having a nonsymmetrical structure along a transfer path by vibration;
setting alignment directions of the transferred parts along the transfer path by passing parts aligned in a first alignment direction and not passing parts aligned in a second alignment direction based on a size difference of contact portions of the parts according to alignment directions of the transferred parts; and
sequentially inserting the parts, the alignment directions of which have been set, into a tray.

15. The part aligning method according to claim 14, wherein the size difference of the contact portions of the parts is a height difference.

16. The part aligning method according to claim 14, wherein the setting the alignment directions of the parts includes changing the alignment directions of the passed parts.

17. The part aligning method according to claim 14, further comprising, prior to the inserting:
sensing the alignment directions of the parts, the alignment directions of which have been set; and
separating the tray from an operation position, if it is sensed that the alignment direction of a part is not a desired alignment direction.

18. The part aligning method according to claim 14, further comprising moving the tray at a designated interval, whenever one row of the tray is filled with the parts, so as to fill a next row with the parts.

19. An aligning apparatus comprising:
a container unit which vibrates to transfer cartridges having a nonsymmetrical structure along a transfer path;
an alignment direction setting unit which receives the cartridges transferred along the transfer path by the container unit and includes a return hole leading to the container unit, the alignment direction setting unit transferring cartridges aligned in a first direction and discharging cartridges aligned in a second direction opposite to the first direction through the return hole to thereby return the discharged cartridges to the vibrating container; and
an ejecting unit which receives and ejects the cartridges transferred by the alignment direction setting unit.

20. The aligning apparatus according to claim 19, wherein:
each of the cartridges has a first end surface which has a first height and a second end surface which is opposite the first end surface and has a second height,
the return hole is formed in a side wall of the alignment direction setting unit and a portion of the return hole has a third height which is less than first height and greater than the second height so that the cartridges aligned in the first direction are transferred past the hole and the cartridges aligned in the second direction pass through the hole and are returned to the container unit.
